(19) United States
(12) Patent Application Publication
(10) Pub. No.: US 2010/0300800 A1
(43) Pub. Date: Dec. 2, 2010

(54) ACOUSTIC GLAZING ELEMENT

(75) Inventors: Jean-Gerard Leconte, Courbevoie (FR); Marc Rehfeld, Ezanville (FR); Pierre Chaussade, Orleans (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/599,705

(22) PCT Filed: May 23, 2008
(86) PCT No.: PCT/FR2008/050898

§ 371 Date: Nov. 19, 2009

Related U.S. Application Data
(60) Provisional application No. 60/939,927, filed on May 24, 2007.

(51) Int. Cl. G10K 11/16; E04B 1/82

(52) U.S. Cl. 181/290; 181/294

(57) ABSTRACT

The invention therefore provides glazing which, to ensure improved acoustic insulation properties, requires not only an acoustic polymeric interlayer but also a suitable distribution of the masses of the elements on either side of the interlayer.

The invention relates to enhanced acoustic glazing, i.e. glazing having enhanced acoustic insulation performances.

The glazing of the invention will be more particularly described in its use in respect of aircraft, more precisely aircraft cockpits, but it also addresses automobiles, locomotives, ships, or buildings (residential buildings, offices, commercial premises), etc.

One particular problem raised by the invention is how to enhance the acoustic insulation performance in an aircraft cockpit, especially for pilot comfort. It is continuously endeavored to reduce the level of noise inside a cockpit so that, in particular, communications during a flight can be heard better, but with a constant concern for improving the safety conditions.

Another problem is how to reduce the weight of cockpit glazing without having a negative impact on its acoustic properties.

Moreover, aircraft glazing must ensure unique performance under all circumstances and whatever the conditions, especially as regards the extreme temperature and pressure conditions, as regards impacts suffered by the glazing due for example to birds, etc.

The pressure exerted on aircraft glazing varies when the aircraft is flying from the ground to a high altitude. Furthermore, there are large pressure gradients and temperature gradients between the internal face and the external face of glazing. The temperatures may for example vary from about −60° C. on the external face side of the glazing, when the aircraft is flying, up to +20° C. on the internal face side.

In the rest of the description, the term “internal” relates to the interior of the device accommodating the glazing, such as the interior of an aircraft, and the term “external” relates to the exterior of the device, such as outside the aircraft. In addition, the term “external” will be used to refer to direct contact with the exterior or a disposition as close as possible to the exterior. The term “internal” will be used to refer to direct contact with the interior or a disposition as close as possible to the interior.

As regards bird impacts, these occur for example when the aircraft is moving at high speed on a runway or when it is flying at low altitude.

Typically, aircraft cockpit glazing is constituted of several rigid substrates, also called plies, made of glass and plastic, which are joined together into a laminate. The weight of the glazing is generally 45 or 70 kg. In the rest of the description, the term “glass” is understood to mean mineral glass.

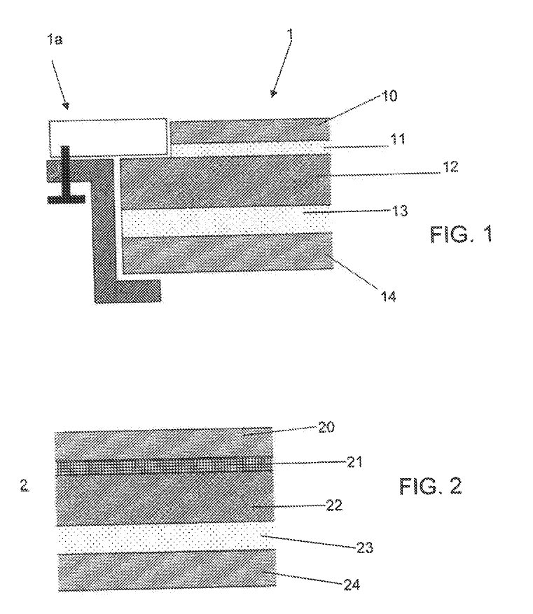

One conventional configuration is for example the following (glazing 1 illustrated in FIG. 1 fixed to the body 1a of an aircraft):
an external glass substrate 10 with a thickness of 3 mm;
a plastic interlayer with a thickness of between 3 and 9 mm, made of polyvinyl butyral (PVB) and/or polyurethane (PU), hereafter referred to as the external interlayer 11;
an intermediate glass substrate 12 with a thickness of 8 or 10 mm;
a standard somewhat rigid PVB sheet 13 with a thickness of 2 to 5 mm; and
an internal glass substrate 14 with a thickness of 6 or 8 mm.

The weight of such cockpit glazing is approximately 45 kg.

As known in the automotive field, the acoustic properties of glazing are improved by using, on the external glass side, an acoustic interlayer, such as an acoustic PVB interlayer, with a thickness of at most 3 mm, which has particular characteristics relating to the loss factor tanδ and the shear modulus G′, as described in particular in United States patents U.S. Pat. No. 7,121,380 and U.S. Pat. No. 6,821,629, both incorporated by reference in the present application.

In trying to apply this principle of using an acoustic interlayer in aircraft cockpit glazing to enhance its acoustic insulation performance, it suffices to replace the 3 mm thick plastic interlayer located adjacent the external glass substrate with acoustic PVB. However, unexpectedly, it turns out that no acoustic improvement is demonstrated, and there is even a deterioration in the acoustic properties within certain frequency ranges.

The acoustic performance of glazing may be illustrated by a curve of the insulation in dB plotted as a function of frequency.

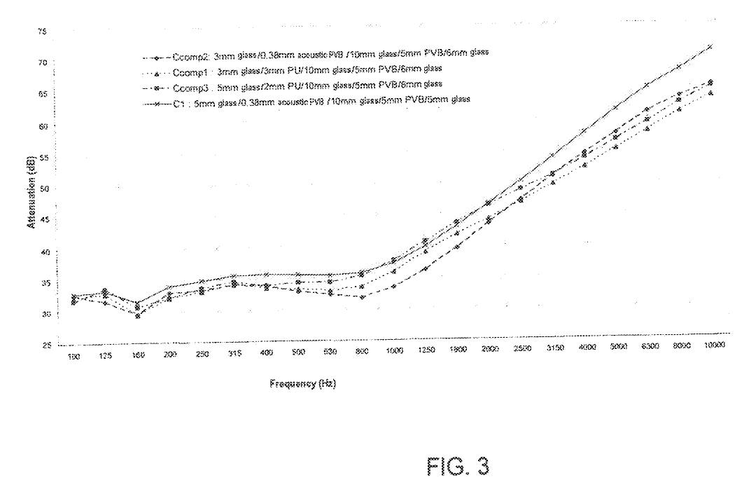

FIG. 3 shows insulation curves at 20° C., for frequencies between 100 and 10 000 Hz, for standard aircraft glazing, in its configuration as described above, for the glazing 1 with glass panes of 3 mm, 10 mm and 6 mm thickness respectively and a PU plastic interlayer of 3 mm thickness (the Ccomp1 curve) and for glazing in which the PU plastic interlayer of 3 mm thickness has been replaced with acoustic PVB of 0.38 mm thickness (the Ccomp2 curve).

This figure shows a deterioration between 600 Hz and 2500 Hz, with a 2 to 3 dB loss of insulation for frequencies between 800 and 2000 Hz, which lie within the audible frequencies. This deterioration is counter to the desired objective of enhancing the performance of acoustic insulation.

The aim of the invention is therefore to provide acoustic glazing, especially for aviation, exhibiting enhanced acoustic insulation performance, while still having stiffness, strength and sealing properties that are especially those expected in the aviation field for meeting the safety standards, in particular having the required bird impact resistance and pressurization sealing performance.

The inventors have in particular demonstrated, in relation to the prior art, that by using at least one external acoustic interlayer, but increasing the thickness of the external glass substrate from 3 mm to 5 mm, glazing of enhanced acoustic insulation performance is obtained.

According to a first embodiment of the invention, the acoustic glazing comprises a first glass substrate, at least one polymeric interlayer, a second glass substrate, a plastic substrate and a third glass substrate, and is characterized in that:
the polymeric interlayer comprises a material having enhanced acoustic damping properties at 20° C. and at 200 Hz, namely a loss factor tanδ of 0.6 or higher and a shear modulus G′ of less than 2×10⁷ N/m²; and
the weight of the first glass substrate placed on one side of the polymeric interlayer is not less than 20% of the total weight of the glazing and the weight of all of the other elements placed on the other side of the polymeric interlayer is also not less than 20% of the total weight of the glazing.

According to a second embodiment of the invention, the acoustic glazing comprises a first glass substrate, at least one polymeric interlayer, and an at least 15 mm thickness of various combined glass substrates and plastic layers, and is characterized in that:
the polymeric interlayer comprises a material having enhanced acoustic damping properties at 20° C. and at 200 Hz, namely a loss factor tanδ of 0.6 or higher and a shear modulus G′ of less than 2×10⁷ N/m²; and
the weight of the first glass substrate placed on one side of the polymeric interlayer is not less than 20% of the total weight of the glazing and the weight of all of the other elements placed on the other side of the polymeric interlayer is also not less than 20% of the total weight of the glazing.

According to one feature, the first glass substrate and the second glass substrate joined on either side of the polymeric interlayer have the same thickness.

The acoustic material of the invention therefore has a loss factor tanδ of 0.6 or higher and a shear modulus G′ of less than 2×10⁷ N/m² at a temperature of 20° C. and at a frequency of 200 Hz. It will be recalled that the loss factor and the shear modulus are measured in a known manner using a viscoanalyzer, for example of the METRAVIB type.

The acoustic interlayer is also such as that described in the United States patents U.S. Pat. No. 7,121,380 and U.S. Pat. No. 6,821,629. The interlayer may have various thicknesses, in particular 0.38 mm, 0.40 mm, 0.45 mm, 0.5 mm, 0.6 mm or 0.76 mm.

Preferably, the acoustic interlayer is based on acoustic polyvinyl butyral (PVB). It may be combined with a commonplace plastic film not having improved acoustic properties, without this impairing the improved acoustic properties of the assembly. For example, the laminating layer, which includes at least one acoustic interlayer film, may be in the PVB-PET-acrylate-PET-PVB form. The interlayer may also comprise an acoustic PVB layer and a standard PVB and/or polyurethane layer.

Surprisingly, it appears that the glass ply located facing one of the faces of the acoustic interlayer is independent in its behavior with respect to the glass ply placed on the other side of the interlayer. Because of the behavior of each glass ply of the glazing with the interlayer, the latter thus works in shear, causing the vibrations to be damped by the dissipated energy and thereby attenuating the noise.

Consequently, by distributing the mass of the glazing differently, depending on the separate thickness of each constituent component, and by incorporating at least one acoustic interlayer film, glazing of enhanced acoustic insulation performance, in particular as regards aerodynamic noise, is obtained.

Surprisingly for the application as aircraft glazing, if the mass of each component placed on either side of the external interlayer, such as an acoustic PVB interlayer, is not modified in relation to the mass of the components of standard aircraft glazing, enhanced performance provided by the acoustic insulation is not achieved.

According to one embodiment of the invention, the first glass substrate has a thickness of between 3 and 8 mm, the polymeric interlayer having a thickness of at least 0.38 mm, and the glazing includes, on the opposite side to the first glass substrate and joined to the polymeric interlayer, a laminated combination formed from at least a glass substrate with a thickness of between 5 and 10 mm, placed against the polymeric interlayer on the opposite side to the first substrate, from a plastic substrate and from an additional glass substrate with a thickness of between 3 and 10 mm.

According to one feature, the plastic substrate of the glazing has a thickness of between 1 and 10 mm and is made of standard polyvinyl butyral or made of polyurethane.

Finally, such acoustic glazing may be intended for various uses, with a view to improving the acoustic insulation of devices in which it is housed. For example, it may constitute aircraft glazing, automotive glazing, railroad glazing or building glazing.

Other details of the invention will now be described in conjunction with the figures, in which:

FIG. 1 illustrates schematically a partial sectional view of standard aircraft glazing;

FIG. 2 is a schematic partial sectional view of glazing according to the invention; and

FIG. 3 illustrates insulation curves for glazing according to the invention and for comparative glazing.

FIGS. 1 and 2 have not been drawn to scale in order to make it easier to examine them.

FIG. 1 has been described above with regard to the prior art.

FIG. 2 illustrates glazing 2 according to the invention, comprising the following constituent components:
a first glass substrate 20, intended for example to be in contact with the outside when the glazing is mounted in its intended final position, this glass substrate preferably having a thickness of 5 mm;
an acoustic polymeric interlayer 21 made of acoustic PVB, the interlayer preferably having a thickness not exceeding 3 mm;
an intermediate glass substrate 22, this glass substrate preferably having a thickness of 10 mm;
a rigid substrate 23 rather made of PVB, which preferably has a thickness of 5 mm, this being standard, non-acoustic, PVB; and
an additional glass substrate 24, intended for example to be in contact with the interior of the device into which the glazing is fitted, this glass substrate preferably having a thickness of 6 mm.

Of course, each of the thicknesses of the constituent components of the glazing may vary, especially within ±40%, in particular ±35%, ±30%, ±25%, ±20%, ±15%, ±10%, ±8%, ±5%, ±3% or ±1%.

As already indicated above, it is not sufficient to use an acoustic interlayer placed anywhere within the glazing in order to achieve the desired noise attenuation within the device into which the glazing is fitted. Aircraft glazing is much thicker and much heavier than automotive glazing and it appears not to be possible to transpose as such the solution suitable for automotive glazing to aircraft glazing.

In addition, the invention provides glazing that includes an interlayer having improved acoustic damping properties and for which the weight of the constituent components of the glazing on either side of the interlayer is balanced so that this weight is not less than 20% of the total weight of the glazing.

Thus, the weight of the external substrate 20 must not be less than 20% of the total weight of the glazing, just like the weight of the combination of substrates 22, 23 and 24.

Preferably, the weight of all the components on each side of the interlayer is not less than 30%, or even not less than 31.25%, of the total weight of the glazing. Of course, percentages above 31.25% and up to 50%, such as 35%, 37%, 40%, 42%, 45% and 50%, are included in all the values claimed by the invention.

The weight may be adjusted more easily by the number of glass panes and/or their thickness on each side of the acoustic polymeric interlayer.

The acoustic polymeric interlayer 21 has, at 20° C. and at 50 Hz, or preferably 200 Hz, a loss factor tanδ of 0.6 or higher and a shear modulus G′ of less than 2×10⁷ N/m².

French patent application 96/14404 and German patent application 19705586.3 are incorporated by reference and describe for example acoustic films for the invention.

According to a preferred embodiment of the invention, the glazing comprises an external glass substrate 20 of 5 mm thickness, an acoustic polymeric interlayer 21 and, on the opposite side to the external substrate, an at least 15 mm thickness of a combination of glass and plastic layers.

Another preferred embodiment of the invention is glazing that comprises an external glass substrate of 3 to 8 mm thickness, acoustic PVB of at least 0.38 mm thickness in order to form the polymeric interlayer, intermediate glass of at least 5 to 8 mm thickness, a plastic substrate and internal glass of at least 3 to 10 mm thickness.

The acoustic polymeric interlayer is based on acoustic PVB. This may be a single acoustic PVB layer or, as a variant, an acoustic PVB layer combined with a nonacoustic plastic layer, such as one made of standard PVB or of polyurethane (PU), without affecting the damping properties of said acoustic layer. For example, it is possible to provide an acoustic PVB layer with a thickness of 0.38 or 0.76 mm combined with a PU layer with a thickness of 9.6 or 5.3 mm.

In FIG. 3, the curve C1 shows the insulation of an example of glazing according to the invention.

The glazing corresponding to this curve comprises:
a first glass substrate 20 with a thickness of 5 mm;
a plastic interlayer 21 made of acoustic PVB with a thickness of 0.38 mm;
an intermediate glass substrate 22 of 10 mm;
a rigid substrate 23 made of standard PVB with a thickness of 5 mm; and
an additional glass substrate 24 with a thickness of 6 mm.

This figure clearly shows that the curve C1 lies above the comparative curves Ccomp1 and Ccomp2 that were described above, and that correspond to glazing not according to the invention. This example of glazing according to the invention thus provides much better noise insulation.

The example according to the invention was compared with other glazing (curve Ccomp3), the acoustic PVB of which was replaced by 2 mm of PU, comprising namely:
a first glass substrate 10 with a thickness of 5 mm;
a plastic interlayer 11 made of PU with a thickness of 2 mm;
an intermediate glass substrate 12 of 10 mm;
a rigid substrate 13 made of PVB with a thickness of 5 mm; and
an additional glass substrate 14 with a thickness of 6 mm.

It may be seen that curve Ccomp3 generally lies below curve C1 and therefore does not have the insulation performance of the example according to the invention.

The invention thus provides glazing which, to have improved acoustic insulation properties, not only requires an acoustic polymeric interlayer but also a suitable distribution of the masses of the elements on either side of the acoustic interlayer, so as to ensure that the equivalent stiffnesses of the elements on either side of the acoustic polymeric interlayer are distributed in a sufficiently uniform manner.

1. An acoustic glazing having enhanced acoustic insulation properties, comprising a first glass substrate, at least one polymeric interlayer, a second glass substrate, a plastic substrate and a third glass substrate, wherein:
the polymeric interlayer comprises a material having enhanced acoustic damping properties at 20° C. and at 200 Hz, a loss factor tanδ of 0.6 or higher and a shear modulus G′ of less than 2×10⁷ N/m²; and
the weight of the first glass substrate placed on one side of the polymeric interlayer is not less than 20% of the total weight of the glazing and the weight of all of the other elements placed on the other side of the polymeric interlayer is also not less than 20% of the total weight of the glazing.

2. An acoustic glazing having enhanced acoustic insulation properties, comprising a first glass substrate, at least one polymeric interlayer, and an at least 15 mm thickness of various combined substrates of glass and plastic layers, wherein:
the polymeric interlayer comprises a material having enhanced acoustic damping properties at 20° C. and at 200 Hz, a loss factor tanδ of 0.6 or higher and a shear modulus G′ of less than 2×10⁷ N/m²; and
the weight of the first glass substrate placed on one side of the polymeric interlayer is not less than 20% of the total weight of the glazing and the weight of all of the other elements placed on the other side of the polymeric interlayer is also not less than 20% of the total weight of the glazing.

3. The acoustic glazing as claimed in claim 1, wherein the first glass substrate and the second glass substrate joined on either side of the polymeric interlayer have the same thickness.

4. The acoustic glazing as claimed in claim 1, wherein the first glass substrate has a thickness of between 3 and 8 mm, in that the polymeric interlayer has a thickness of at least 0.38 mm, and in that the acoustic glazing comprises, on the opposite side to the first glass substrate and joined to the polymeric interlayer, a laminated combination formed from at least a glass substrate with a thickness of between 5 and 10 mm, placed against the polymeric interlayer on the opposite side to the first substrate, from a plastic substrate and from an additional glass substrate with a thickness of between 3 and 10 mm.

5. The acoustic glazing as claimed in claim 1, wherein the polymeric interlayer is based on acoustic polyvinyl butyral.

6. The acoustic glazing as claimed in claim 1, wherein the polymeric interlayer comprises at least one acoustic polyvinyl butyral layer and a polyurethane and/or standard polyvinyl butyral layer.

7. The acoustic glazing as claimed in claim 1, wherein the plastic substrate has a thickness of between 1 and 10 mm and is made of standard polyvinyl butyral or made of polyurethane.

8. The acoustic glazing as claimed in claim 1, wherein it constitutes aircraft glazing, automotive glazing, railroad glazing or building glazing.

9. The acoustic glazing as claimed in claim 2, wherein the first glass substrate and the various combined substrates of glass and plastic layers joined on the other side of the polymeric interlayer have the same thickness.

10. The acoustic glazing as claimed in claim 2, wherein the first glass substrate has a thickness of between 3 and 8 mm, in that the polymeric interlayer has a thickness of at least 0.38 mm, and in that the acoustic glazing comprises, on the opposite side to the first glass substrate and joined to the polymeric interlayer, a laminated combination formed from at least a glass substrate with a thickness of between 5 and 10 mm, placed against the polymeric interlayer on the opposite side to the first substrate, from a plastic substrate and from an additional glass substrate with a thickness of between 3 and 10 mm.

11. The acoustic glazing as claimed in claim 2, wherein the polymeric interlayer is based on acoustic polyvinyl butyral.

12. The acoustic glazing as claimed in claim 2, wherein the polymeric interlayer comprises at least one acoustic polyvinyl butyral layer and a polyurethane and/or standard polyvinyl butyral layer.

13. The acoustic glazing as claimed in claim 2, wherein the plastic substrate has a thickness of between 1 and 10 mm and is made of standard polyvinyl butyral or made of polyurethane.

14. The acoustic glazing as claimed in claim 2, wherein it constitutes aircraft glazing, automotive glazing, railroad glazing or building glazing.
